(19) United States
(12) Patent Application Publication
(10) Pub. No.: US 2024/0256416 A1
(43) Pub. Date: Aug. 1, 2024

(54) SOFTWARE-DEFINED PHYSICAL DISPLAY IN HCI AND EDGE COMPUTING SYSTEMS

(71) Applicant: Dell Products L.P., Round Rock, TX (US)

(72) Inventors: Haijun ZHONG, Shanghai (CN); Muzhar S. KHOKHAR, Shrewsbury, MA (US); XiaoJun WU, Shanghai (CN)

(73) Assignee: Dell Products L.P., Round Rock, TX (US)

(21) Appl. No.: 18/161,838

(22) Filed: Jan. 30, 2023

(51) Int. Cl. G06F 11/32

(52) U.S. Cl. CPC G06F 11/325; G06F 9/542

(57) ABSTRACT

An information handling system may include at least one processor, a memory, and local status notification hardware. The information handling system may be configured to: receive configuration definition information indicating a correspondence between events and notifications that are configured to be output by the local status notification hardware; and cause non-local status notifications to be output by the local status notification hardware in accordance with the configuration definition information.

### TECHNICAL FIELD

The present disclosure relates in general to information handling systems, and more particularly to techniques for management of information handling systems.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Hyper-converged infrastructure (HCl) is an IT framework that combines storage, computing, and networking into a single system in an effort to reduce data center complexity and increase scalability. Hyper-converged platforms may include a hypervisor for virtualized computing, software-defined storage, and virtualized networking, and they typically run on standard, off-the-shelf servers. One type of HCl solution is the Dell EMC VxRail™ system. Some examples of HCl systems may operate in various environments (e.g., an HCl management system such as the VMware® vSphere® ESXi™ environment, or any other HCl management system). Some examples of HCl systems may operate as software-defined storage (SDS) cluster systems (e.g., an SDS cluster system such as the VMware® vSAN™ system, or any other SDS cluster system).

In the HCl context (as well as other contexts), information handling systems may execute virtual machines (VMs) for various purposes. A VM may generally comprise any program of executable instructions, or aggregation of programs of executable instructions, configured to execute a guest operating system on a hypervisor or host operating system in order to act through or in connection with the hypervisor/host operating system to manage and/or control the allocation of hardware resources such as memory, central processing unit time, disk space, and input and output devices, and provide an interface between such hardware resources and application programs hosted by the guest operating system.

Computer beeps, lights, and liquid-crystal display (LCD) panels have sometimes been used to provide various status, warning, and error messages. For example, a speaker may beep in a defined sequence during a system's power-on self-test (POST) if a memory error is detected, a light may indicate hard drive activity, an LCD panel may provide information about system temperatures, etc. The term “local status notifications” is used herein to refer generally to such beeps, lighting, and displaying of LCD panel information. The term “local status notification hardware” is used to refer generally to the information handling resources (e.g., speakers, lighting elements, and LCD panels) that provide such notifications. In some implementations, local status notification hardware may also include near-field communication (NFC) hardware, QR code displays, etc. that may be used via a mobile device to display notifications on a screen thereof.

With regard to LCD panels, the term “local status notification hardware” be understood to include small, auxiliary displays of the type used for hardware status (typically under 8 inches diagonal in size); however, it should be understood not to include full-size monitors (typically over 8 inches diagonal in size).

Traditionally, however, local status notifications at a given information handling system have been used only for local hardware information (that is, for notifications regarding the information handling resources that are part of that information handling system). However, in many scenarios (e.g., HCl systems, hybrid cloud systems, etc.), it is more useful to regard hardware and software as parts of a whole system, and to provide notifications that relate to any part of that system. For example, notifications regarding other nodes of an HCl cluster, notifications regarding software components, etc. may be displayed in some embodiments.

For example, during so-called “zero-touch” operations, an edge device may have no display connected, and management may be conducted from a control panel that is geographically far away from the system. Further, the control panel itself may be a cloud-based control panel that is accessible over the internet from anywhere.

It would be desirable if the local status notifications for the edge device could provide information regarding the status of the whole HCl system, rather than only the local hardware that is specific to that node. Then a local user (who may not be technically proficient) may obtain relevant information and report it to a technician.

For example, embodiments of this disclosure allow for local status notification hardware at an individual node to provide information regarding non-local status notifications. For purposes of this disclosure, the term “non-local status notifications” may include cluster-level status data, such as system health, VM workloads, CPU utilization, utilization, memory utilization, network hardware and software warnings, hardware and software errors, etc.; non-local status notifications may further include any notifications that relate to information handling resources that are not part of the local information handling system, such as hardware and/or software notifications relating to other information handling systems.

It should be noted that the discussion of a technique in the Background section of this disclosure does not constitute an admission of prior-art status. No such admissions are made herein, unless clearly and unambiguously identified as such.

### SUMMARY

In accordance with the teachings of the present disclosure, the disadvantages and problems associated with management of information handling systems may be reduced or eliminated.

In accordance with embodiments of the present disclosure, an information handling system may include at least one processor, a memory, and local status notification hardware. The information handling system may be configured to: receive configuration definition information indicating a correspondence between events and notifications that are configured to be output by the local status notification hardware; and cause non-local status notifications to be output by the local status notification hardware in accordance with the configuration definition information.

In accordance with these and other embodiments of the present disclosure, a method may include, at an information handling system including local status notification hardware, receiving configuration definition information indicating a correspondence between events and notifications that are configured to be output by the local status notification hardware; and causing non-local status notifications to be output by the local status notification hardware in accordance with the configuration definition information.

In accordance with these and other embodiments of the present disclosure, an article of manufacture may include a non-transitory, computer-readable medium having computer-executable instructions thereon that are executable by a processor of an information handling system, wherein the information handling system includes local status notification hardware, the instructions executable for: receiving configuration definition information indicating a correspondence between events and notifications that are configured to be output by the local status notification hardware; and causing non-local status notifications to be output by the local status notification hardware in accordance with the configuration definition information.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example information handling system, in accordance with embodiments of the present disclosure; and

FIG. 2 illustrates a block diagram of a software-defined local status notification system, in accordance with embodiments of the present disclosure.

### DETAILED DESCRIPTION

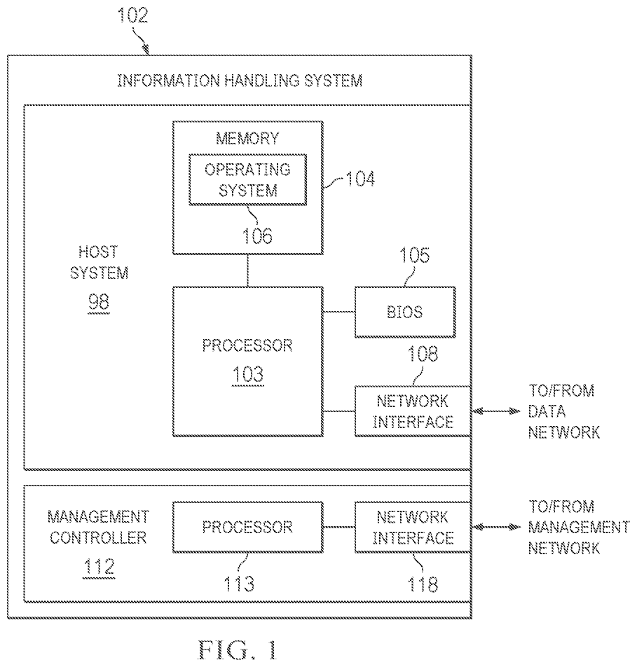

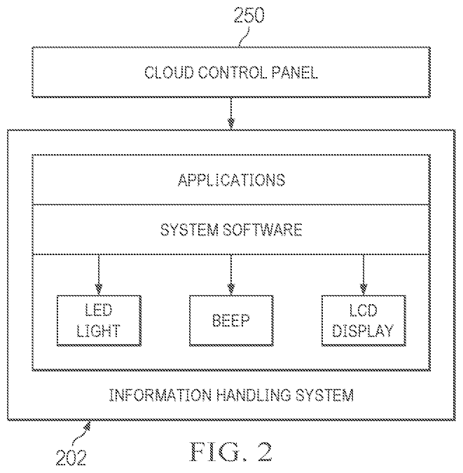

Preferred embodiments and their advantages are best understood by reference to FIGS. 1 and 2, wherein like numbers are used to indicate like and corresponding parts.

For the purposes of this disclosure, the term “information handling system” may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and in may vary size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For purposes of this disclosure, when two or more elements are referred to as “coupled” to one another, such term indicates that such two or more elements are in electronic communication or mechanical communication, as applicable, whether connected directly or indirectly, with or without intervening elements.

When two or more elements are referred to as “coupleable” to one another, such term indicates that they are capable of being coupled together.

For the purposes of this disclosure, the term “computer-readable medium” (e.g., transitory or non-transitory computer-readable medium) may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; communications media such as wires, optical fibers, microwaves, radio waves, and other electromagnetic and/or optical carriers; and/or any combination of the foregoing.

For the purposes of this disclosure, the term “information handling resource” may broadly refer to any component system, device, or apparatus of an information handling system, including without limitation processors, service processors, basic input/output systems, buses, memories, I/O devices and/or interfaces, storage resources, network interfaces, motherboards, and/or any other components and/or elements of an information handling system.

For the purposes of this disclosure, the term “management controller” may broadly refer to an information handling system that provides management functionality (typically out-of-band management functionality) to one or more other information handling systems. In some embodiments, a management controller may be (or may be an integral part of) a service processor, a baseboard management controller (BMC), a chassis management controller (CMC), or a remote access controller (e.g., a Dell Remote Access Controller (DRAC) or Integrated Dell Remote Access Controller (iDRAC)).

FIG. 1 illustrates a block diagram of an example information handling system 102, in accordance with embodiments of the present disclosure. In some embodiments, information handling system 102 may comprise a server chassis configured to house a plurality of servers or “blades.” In other embodiments, information handling system 102 may comprise a personal computer (e.g., a desktop computer, laptop computer, mobile computer, and/or notebook computer). In yet other embodiments, information handling system 102 may comprise a storage enclosure configured to house a plurality of physical disk drives and/or other computer-readable media storing for data (which may generally be referred to as “physical storage resources”). As shown in FIG. 1, information handling system 102 may comprise a processor 103, a memory 104 communicatively coupled to processor 103, a BIOS 105 (e.g., a UEFI BIOS) communicatively coupled to processor 103, a network interface 108 communicatively coupled to processor 103, and a management controller 112 communicatively coupled to processor 103.

In operation, processor 103, memory 104, BIOS 105, and network interface 108 may comprise at least a portion of a host system 98 of information handling system 102. In addition to the elements explicitly shown and described, information handling system 102 may include one or more other information handling resources.

Processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104 and/or another component of information handling system 102.

Memory 104 may be communicatively coupled to processor 103 and may include any system, device, or apparatus configured to retain program instructions and/or data for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to information handling system 102 is turned off.

As shown in FIG. 1, memory 104 may have stored thereon an operating system 106. Operating system 106 may executable comprise any program of instructions (or aggregation of programs of executable instructions) configured to manage and/or control the allocation and usage of hardware resources such as memory, processor time, disk space, and input and output devices, and provide an interface between such hardware resources and application programs hosted by operating system 106. In addition, operating system 106 may include all or a portion of a network stack for network communication via a network interface (e.g., network interface 108 for communication over a data network). Although operating system 106 is shown in FIG. 1 as stored in memory 104, in some embodiments operating system 106 may be stored in storage media accessible to processor 103, and active portions of operating system 106 may be transferred from such storage media to memory 104 for execution by processor 103.

Network interface 108 may comprise one or more suitable systems, apparatuses, or devices operable to serve as an interface between information handling system 102 and one or more other information handling systems via an in-band network. Network interface 108 may enable information handling system 102 to communicate using any suitable transmission protocol and/or standard. In these and other embodiments, network interface 108 may comprise a network interface card, or “NIC.” In these and other embodiments, network interface 108 may be enabled as a local area network (LAN)-on-motherboard (LOM) card.

Management controller 112 may be configured to provide management functionality for the management of information handling system 102. Such management may be made by management controller 112 even if information handling system 102 and/or host system 98 are powered off or powered to a standby state. Management controller 112 may include a processor 113, memory, and a network interface 118 separate from and physically isolated from network interface 108.

As shown in FIG. 1, processor 113 of management controller 112 may be communicatively coupled to processor 103. Such coupling may be via a Universal Serial Bus (USB), System Management Bus (SMBus), and/or one or more other communications channels.

Network interface 118 may be coupled to a management network, which may be separate from and physically isolated from the data network as shown. Network interface 118 of management controller 112 may comprise any suitable system, apparatus, or device operable to serve as an interface between management controller 112 and one or more other information handling systems via an out-of-band management network. Network interface 118 may enable management controller 112 to communicate using any suitable transmission protocol and/or standard. In these and other embodiments, network interface 118 may comprise a network interface card, or “NIC.” Network interface 118 may be the same type of device as network interface 108, or in other embodiments it may be a device of a different type.

As discussed above, embodiments of this disclosure provide improvements in management of information handling systems 102 (e.g., edge nodes of an HCl system). It should be noted that while the scenario of an edge deployment is discussed in detail herein for the sake of concreteness, other embodiments are also specifically contemplated within the scope of this disclosure.

In particular, embodiments may define different local status notifications to correspond to different types of cluster-level events and statuses. In one embodiment, these definitions may be managed by management controller 112. For example, management controller 112 may receive definitions from a cloud-based control panel to the way that events and statuses are to be indicated by the local status notification hardware.

Turning FIG. 2, a software-defined local status notification system is shown, including an information handling system 202 communicatively coupled to a cloud control panel 250.

In one embodiment, cloud control panel 250 may distribute configuration definitions for the local status notification hardware at information handling system 202, including LED lights, speakers configured to provide beep notifications, LCD displays, and other hardware. In one embodiment, information handling system 202 may be an HCl edge system. The configuration definitions may be synchronized between all edge systems, or specific edge systems may receive separate definitions (e.g., if different local status notification hardware is present at the different edge systems).

Configuration definitions may generally include any information that establishes a correspondence between particular events and particular notifications. For example, a definition might create a rule that a cluster-level event such as an abnormal node shutdown should lead to a speaker beeping in a certain pattern, etc.

Configuration definitions may be pushed from the cloud control panel 250 to a management controller of information handling system 202 for implementation. They may also be stored locally, such that they may continue in force even after a reboot of information handling system 202.

In another embodiment, local status notifications may be used to provide information regarding software state in addition to hardware state. For example, if a particular edge computing system loses connectivity with cloud control panel 250, then cloud control panel 250 may cause the other edge systems to display information regarding the loss of connectivity and identifying the particular system that is having problems. This may allow a user to determine more quickly where the problem is. In another embodiment, cloud control panel 250 may preemptively transmit definition information to the edge systems that cause the particular system to alert the user (e.g., by beeping) when it loses connectivity.

In another embodiment, local status notification hardware may function as a software-defined user interface element. For example, a default configuration definition for the local status notification hardware may be provisioned at the factory, but a user may alter or customize that definition in the field.

This disclosure encompasses all changes, substitutions, variations, alterations, and modifications to the exemplary embodiments herein that a person having ordinary skill in the art would comprehend. Similarly, where appropriate, the appended claims encompass all changes, substitutions, variations, alterations, and modifications to the exemplary embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

Further, reciting in the appended claims that a structure is “configured to” or “operable to” perform one or more tasks is expressly intended not to invoke 35 U.S.C. § 112 (f) for that claim element. Accordingly, none of the claims in this application as filed are intended to be interpreted as having means-plus-function elements. Should Applicant wish to invoke § 112 (f) during prosecution, Applicant will recite claim elements using the “means for [performing a function]” construct.

All examples and conditional language recited herein are intended for pedagogical objects to aid the reader in understanding the invention and the concepts contributed by the inventor to furthering the art, and are construed as being without limitation to such specifically recited examples and conditions. Although embodiments of the present inventions have been described in detail, it should be understood that various changes, substitutions, and alterations could be made hereto without departing from the spirit and scope of the disclosure.

What is claimed is:

1. An information handling system comprising:
at least one processor;
a memory; and
local status notification hardware;
wherein the information handling system is configured to:
receive configuration definition information indicating a correspondence between events and notifications that are configured to be output by the local status notification hardware; and
cause non-local status notifications to be output by the local status notification hardware in accordance with the configuration definition information.

2. The information handling system of claim 1, wherein the information handling system is a hyper-converged infrastructure (HCl) system.

3. The information handling system of claim 2, wherein the non-local status notifications include hardware and/or software events relating to other nodes of the HCl system.

4. The information handling system of claim 1, wherein the configuration definition information is customizable by a user of the information handling system.

5. The information handling system of claim 1, wherein the local status information hardware includes at least one component selected from the group consisting of: light-emitting diodes, speakers configured to produce sound, and liquid-crystal displays having a diagonal size less than 8 inches.

6. The information handling system of claim 1, further comprising a management controller configured to provide out-of-band management of the information handling system and further configured to cause the non-local status notifications to be output by the local status notification hardware.

7. A method comprising:
at an information handling system including local status notification hardware, receiving configuration definition information indicating a correspondence between events and notifications that are configured to be output by the local status notification hardware; and
causing non-local status notifications to be output by the local status notification hardware in accordance with the configuration definition information.

8. The method of claim 7, wherein the information handling system is a hyper-converged infrastructure (HCl) system.

9. The method of claim 8, wherein the non-local status notifications include hardware and/or software events relating to other nodes of the HCl system.

10. The method of claim 7, wherein the configuration definition information is customizable by a user of the information handling system.

11. The method of claim 7, wherein the local status information hardware includes at least one component selected from the group consisting of: light-emitting diodes, speakers configured to produce sound, and liquid-crystal displays having a diagonal size less than 8 inches.

12. The method of claim 7, wherein the information handling system further comprises a management controller configured to provide out-of-band management of the information handling system and further configured to cause the non-local status notifications to be output by the local status notification hardware.

13. An article of manufacture comprising a non-transitory, computer-readable medium having computer-executable instructions thereon that are executable by a processor of an information handling system, wherein the information handling system includes local status notification hardware, the instructions executable for:
receiving configuration definition information indicating a correspondence between events and notifications that are configured to be output by the local status notification hardware; and
causing non-local status notifications to be output by the local status notification hardware in accordance with the configuration definition information.

14. The article of claim 13, wherein the information handling system is a hyper-converged infrastructure (HCl) system.

15. The article of claim 14, wherein the non-local status notifications include hardware and/or software events relating to other nodes of the HCl system.

16. The article of claim 13, wherein the configuration definition information is customizable by a user of the information handling system.

17. The article of claim 13, wherein the local status information hardware includes at least one component selected from the group consisting of: light-emitting diodes, speakers configured to produce sound, and liquid-crystal displays having a diagonal size less than 8 inches.

18. The article of claim 13, wherein the information handling system further comprises a management controller configured to provide out-of-band management of the information handling system and further configured to cause the non-local status notifications to be output by the local status notification hardware.
